(19) United States
(12) Patent Application Publication
(10) Pub. No.: US 2013/0128438 A1
(43) Pub. Date: May 23, 2013

(54) HEAT DISSIPATING SYSTEM

(71) Applicants: CHENG-YEN HUANG, Tu-Cheng (TW); SHENG-WEI SU, Tu-Cheng (TW)

(72) Inventors: CHENG-YEN HUANG, Tu-Cheng (TW); SHENG-WEI SU, Tu-Cheng (TW)

(73) Assignee: HON HAI PRECISION INDUSTRY CO., LTD., Tu-Cheng (TW)

(21) Appl. No.: 13/559,561

(22) Filed: Jul. 26, 2012

(30) Foreign Application Priority Data
Nov. 18, 2011 (TW) 100221870

(51) Int. Cl. G06F 1/20

(52) U.S. Cl. 361/679.4; 361/679.47

(57) ABSTRACT

An exemplary heat dissipating system includes a motherboard, a plurality of temperature sensors connected to the motherboard for sampling a temperature of the motherboard, a FCB establishing a wireless communication with the motherboard, and a plurality of fans. The motherboard receives and processes the temperature data from the plurality of temperature sensors to transform the temperature data into a wireless signal. The FCB obtains the temperature data through the wireless communication, and controls the rotation speed of the plurality of fans according to the temperature data.

### BACKGROUND

1. Technical Field

The disclosure generally relates to container data centers (CDCs), and particularly to a heat dissipating system for a CDC.

2. Description of the Related Art

A typical heat dissipating system for a CDC includes a plurality of fans, a fan control board (FCB), a motherboard, and a plurality of temperature sensors. The plurality of temperature sensors sample temperature data of the motherboard, and transmit the sampled temperature data to the motherboard. The motherboard receives the temperature data from the temperature sensors and transmits the received temperature data to the FCB. The FCB controls the rotation speed of the plurality of fans according to the temperature data for the motherboard heat dissipation.

In general, the motherboard has a hot-swap function, and is connected to the FCB through a special connector and a special cable. For example, an intelligent platform management interface (IPMI) or a RJ-45 port are separately set on the motherboard and the FCB. The IPMI or the RJ-45 port are connected through an intelligent platform management bus or a network line, which adds structural complication and cost of the heat dissipating system.

Therefore, there is room for improvement within the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several diagrams. Wherever possible, the same reference numbers are used throughout the drawings to refer to the same or like elements of an embodiment.

FIG. 1 is a block diagram of a heat dissipating system, according to a first exemplary embodiment.

FIG. 2 is a block diagram of a heat dissipating system, according to a second exemplary embodiment.

FIG. 3 is a block diagram of a heat dissipating system, according to a third exemplary embodiment.

### DETAILED DESCRIPTION

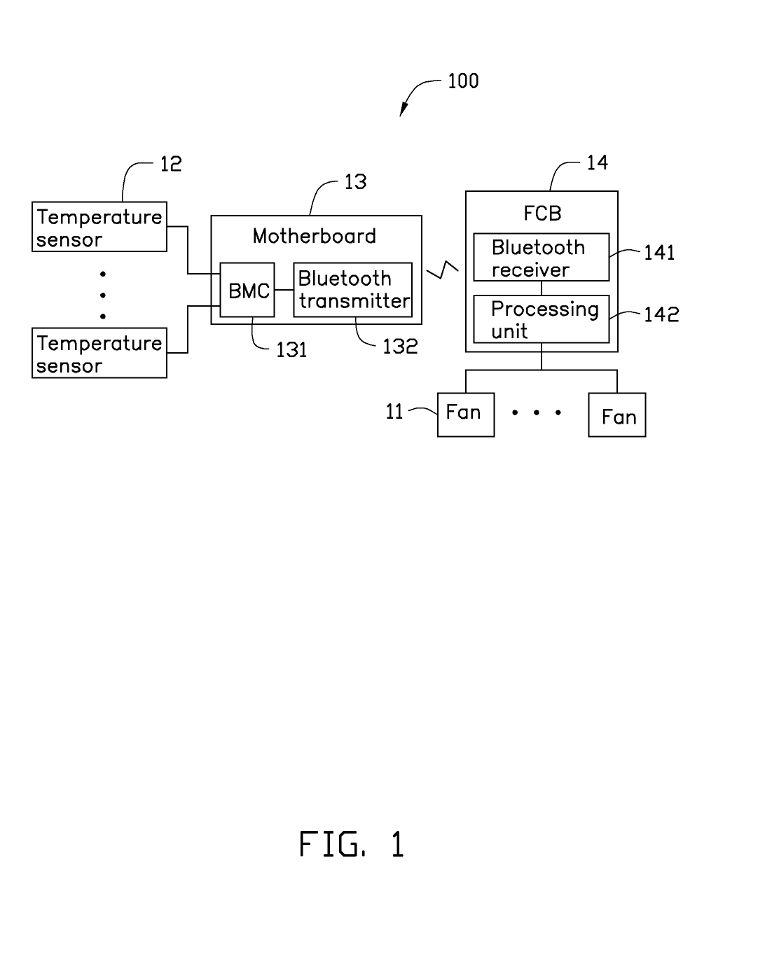

FIG. 1 is a block diagram of a heat dissipating system 100, according to a first exemplary embodiment. The heat dissipating system 100 can be set in a container data center (CDC) or other suitable environments, and includes a plurality of fans 11, a plurality of temperature sensors 12, a motherboard 13, and a fan control board (FCB) 14.

The plurality of fans 11 are configured for generating cool air for dissipating heat generated by the motherboard 13.

The plurality of temperature sensors 12 are used to sample a temperature of the motherboard 13. It can be understood that the plurality of temperature sensors 12 can be mounted on the motherboard 13 directly, or mounted on an impressible position of the motherboard 13, for example an air inlet or an air outlet of the motherboard 13.

The motherboard 13 is electrically connected to the plurality of temperature sensors 12. The motherboard 13 receives and processes the temperature data sampled by the temperature sensors 12 to transform the temperature data into a wireless signal.

In detail, the motherboard 13 includes a baseboard management controller (BMC) 131 and a data transmitter (not labeled). The BMC 131 is connected to the plurality of the temperature sensors 12. The BMC 131 receives and processes the temperature data from temperature sensors 12 to transform the temperature data into a wireless signal. In this embodiment, the data transmitter is a BLUETOOTH transmitter 132. The BLUETOOTH transmitter 132 is connected to the BMC 131 through an intelligent platform management bus. The BLUETOOTH transmitter 132 receives the wireless signal, and sends the wireless signal to the FCB 14.

The FCB 14 includes a data receiver (not labeled) and a processing unit 142. In this embodiment, the data receiver is a BLUETOOTH receiver 141. The BLUETOOTH receiver 141 establishes a wireless communication with the BLUETOOTH transmitter 132 through typical BLUETOOTH technology. The BLUETOOTH receiver 141 obtains the temperature data from the BLUETOOTH transmitter 132. The processing unit 142 can be a central processing unit. The processing unit 142 is connected to BLUETOOTH receiver 141 and the plurality of fans 11. The processing unit 142 receives the temperature data from the BLUETOOTH receiver 141, and correspondingly controls the rotation speed of the plurality of fans 11 according to the temperature data to provide more or less airflow as needed, thereby dissipating heat generated by the motherboard 13.

In use, the motherboard 13 is inserted in a predetermined position of the CDC, and establishes a wireless communication with the FCB 14. The plurality of the temperature sensors 12 are mounted on the motherboard 13 or an impressible position of the motherboard 13, such as an air inlet or an air outlet of the motherboard 13.

The plurality of the temperature sensors 12 sample a temperature of the motherboard 13, and send the sampled temperature data to the BMC 131. The BMC 131 transmits the temperature data through the BLUETOOTH transmitter 132. The

BLUETOOTH receiver 142 obtains the temperature data from the BLUETOOTH transmitter 132 via wireless network, and sends the temperature data to the processing unit 142. Then, according to the temperature data, the processing unit 142 controls the rotation speed of the plurality of the fans 11 to provide more or less airflow as needed, thereby dissipating heat generated by the motherboard 13.

Furthermore, once a motherboard 13 inserted in the predetermined position of the CDC, the BLUETOOTH transmitter 132 of the motherboard 13 will transmit corresponding registered information (e.g., number of the motherboard 13) to the BLUETOOTH receiver 141 via typical BLUETOOTH technology to apply register. Thus, according to the registered information, the BLUETOOTH receiver 141 can determine if the motherboard 13 is inserted in the CDC, thereby supporting a hot-swap function.

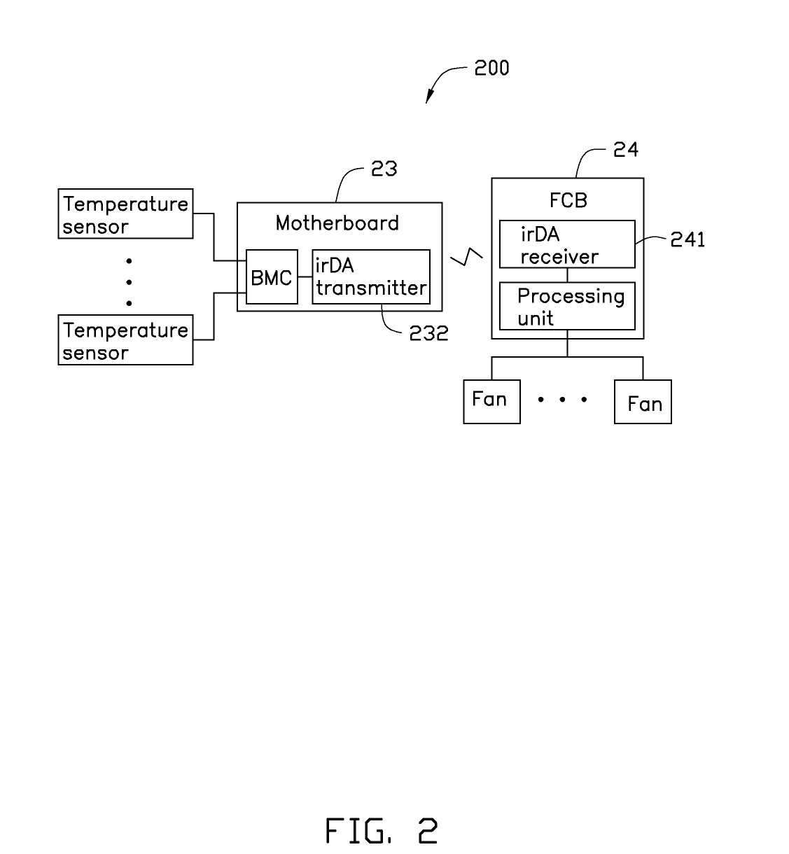

FIG. 2 shows a heat dissipating system 200, according to a second exemplary embodiment. The heat dissipating system 200 differs from the heat dissipating system 100 only in that the BLUETOOTH transmitter 132 and the BLUETOOTH receiver 141 are respectively replaced by an infrared data association (irDA) transmitter 232 and an irDA receiver 241. The irDA receiver 241 establishes a wireless communication with the irDA transmitter 232 through infrared technology.

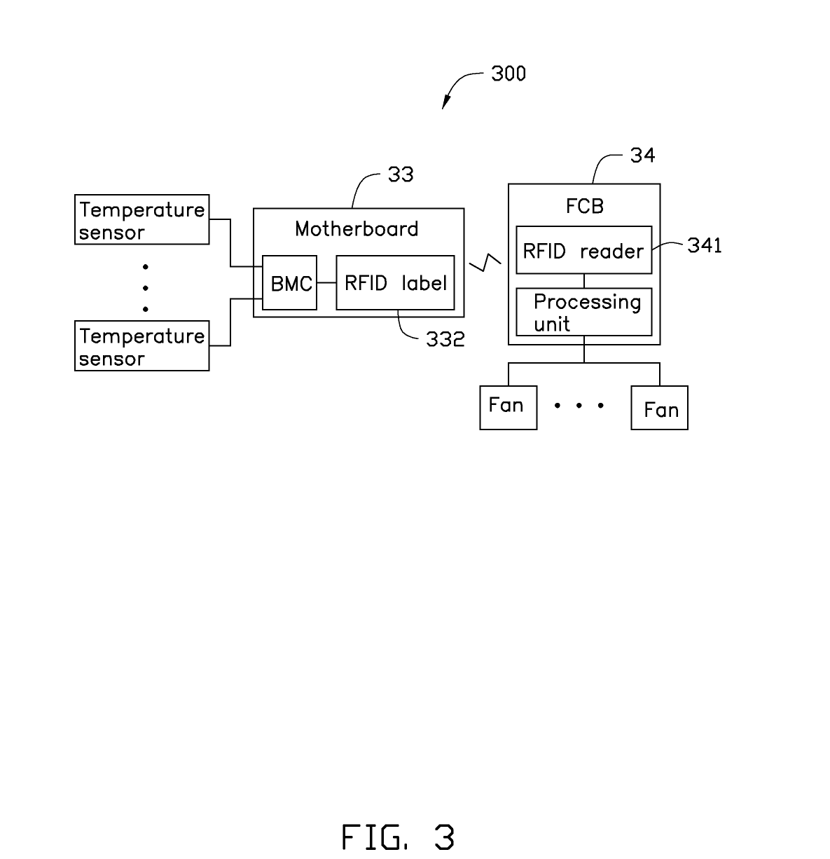

FIG. 3 shows a heat dissipating system 300, according to a third exemplary embodiment. The heat dissipating system 300 differs from the heat dissipating system 100 only in that the BLUETOOTH transmitter 132 and the BLUETOOTH receiver 141 are respectively replaced by a radio frequency identification (RFID) label 332 and a RFID reader 341. The RFID reader 341 establishes a wireless communication with the

RFID label 332 through radio identification technology.

Accordingly, the motherboard 13/23/23 of the heat dissipating system 100/200/300 can establish a wireless communication with the FCB 14/24/34 through BLUETOOTH technology, infrared technology, or radio identification technology, thereby making the connection manner between the motherboard 13/23/23 and the FCB 14/24/34 simpler, and reducing the cost of the heat dissipating system 100/200/300 effectively.

In the present specification and claims, the word “a” or “an” preceding an element does not exclude the presence of a plurality of such elements. Further, the word “comprising” does not exclude the presence of elements or steps other than those listed.

It is to be also understood that even though numerous characteristics and advantages of exemplary embodiments have been set forth in the foregoing description, together with details of the structures and functions of the embodiments, the disclosure is illustrative only, and changes may be made in detail, especially in matters of arrangement of parts within the principles of this disclosure to the full extent indicated by the broad general meaning of the terms in which the appended claims are expressed.

What is claimed is:

1. A heat dissipating system, comprising:
a motherboard;
a plurality of temperature sensors connected to the motherboard and configured for sampling a temperature of the motherboard;
a fan control board (FCB) establishing a wireless communication with the motherboard; and
a plurality of fans connected to the FCB; wherein the motherboard receives and processes the temperature data from the plurality of temperature sensors to transform the temperature data into a wireless signal, the FCB obtains the temperature data through the wireless communication, and controls the rotation speed of the plurality of fans according to the temperature data.

2. The heat dissipating system of claim 1, wherein the motherboard comprises a baseboard management controller (BMC) connected to the plurality of temperature sensors, the BMC obtains the temperature data from the plurality of temperature sensors, and transforms the temperature data into the wireless signal.

3. The heat dissipating system of claim 2, wherein the motherboard comprises a data transmitter connected to the BMC, and used to receive and transmit the wireless signal.

4. The heat dissipating system of claim 3, wherein the FCB comprises a data receiver established the wireless communication with the data transmitter, and used to obtain the temperature data.

5. The heat dissipating system of claim 4, wherein the FCB comprises a processing unit connected to the data receiver, and used to receive the temperature data, and control the rotation speed of the plurality of fans.

6. The heat dissipating system of claim 4, wherein the data transmitter and the data receiver are separately a BLUETOOTH transmitter and a BLUETOOTH receiver, and the data transmitter establishes the wireless communication with the data receiver through BLUETOOTH technology.

7. The heat dissipating system of claim 4, wherein the data transmitter and the data receiver are separately an infrared data association (irDA) transmitter and an irDA receiver, and the irDA transmitter establishes the wireless communication with the irDA receiver through infrared technology.

8. The heat dissipating system of claim 4, wherein the data transmitter and the data receiver are separately a radio frequency identification (RFID) label and a RFID reader, and the RFID label establishes the wireless communication with the RFID reader through radio identification technology.

9. The heat dissipating system of claim 1, wherein the plurality of temperature sensors are mounted on the motherboard.

10. The heat dissipating system of claim 1, wherein the plurality of temperature sensors are mounted on an impressible position of the motherboard.

11. The heat dissipating system of claim 10, wherein the impressible position is an air inlet of the motherboard.

12. The heat dissipating system of claim 10, wherein the impressible position is an air outlet of the motherboard.

13. The heat dissipating system of claim 4, wherein the data transmitter of the motherboard transmits corresponding registered information to the data receiver via wireless network to apply register when the motherboard is inserted in a container data center (CDC), and the data receiver determines if the motherboard is inserted in the CDC according to the registered information, thereby supporting a hot-swap function.

14. A heat dissipating system, comprising:
a motherboard comprising:
a data transmitter; and
a FCB comprising:
a data receiver; wherein the data receiver establishes a wireless communication with the data transmitter through BLUETOOTH technology, infrared technology, or radio identification technology.

15. The heat dissipating system of claim 14, wherein the data transmitter and the data receiver are separately a BLUETOOTH transmitter and a BLUETOOTH receiver, and the data transmitter establishes the wireless communication with the data receiver through the BLUETOOTH technology.

16. The heat dissipating system of claim 14, wherein the data transmitter and the data receiver are separately an irDA transmitter and an irDA receiver, and the irDA transmitter establishes the wireless communication with the irDA receiver through the infrared technology.

17. The heat dissipating system of claim 14, wherein the data transmitter and the data receiver are separately a RFID label and a RFID reader, and the RFID label establishes the wireless communication with the RFID reader through the radio identification technology.
